(19) United States
(12) Patent Application Publication
(10) Pub. No.: US 2024/0281180 A1
(43) Pub. Date: Aug. 22, 2024

(54) PRINTING SYSTEM PERMITTING PRINTING OF ONE OR MORE SHEETS IN EXCESS OF THE NUMBER OF PRINTABLE SHEETS

(71) Applicant: BROTHER KOGYO KABUSHIKI KAISHA, Nagoya (JP)

(72) Inventor: Yutaka TAKIJIRI, Nagoya (JP)

(73) Assignee: BROTHER KOGYO KABUSHIKI KAISHA, Nagoya (JP)

(21) Appl. No.: 18/418,884

(22) Filed: Jan. 22, 2024

(30) Foreign Application Priority Data
Feb. 20, 2023 (JP) 2023-024683

(51) Int. Cl. G06F 3/12

(52) U.S. Cl. CPC G06F 3/1239; G06F 3/1203

(57) ABSTRACT

A printing system includes a management server and a printer. A server controller performs an automated reloading process to increase the number of printable sheets by requesting completion of fee payment, and transmits reloading-result information to the printer. The printer controller updates the sheet information on the number of printable sheets. The printer controller determines whether a permission condition is satisfied. The permission condition includes a condition that: the printer is in an online state; and an enabled automated-reloading setting is stored in the printer. When the permission condition is satisfied, the printer controller permits printing of one or more sheets in excess of the number of printable sheets, and updates the sheet information by counting the number of actually printed sheets printed after the permitting. The number of actually printed sheets includes an excessive number of sheets printed in excess of the number of printable sheets after the permitting.

### REFERENCE TO RELATED APPLICATIONS

This application claims priority from Japanese Patent Application No. 2023-024683 filed on Feb. 20, 2023. The entire content of the priority application is incorporated herein by reference.

### BACKGROUND ART

In conventional printing services, users are charged for printing on a pay-as-you-go basis. For example, the number of printable sheets corresponding to a charged amount is maintained on both a management server and a printer. When the user performs an operation to execute the printing the number of sheets that exceeds the number of printable sheets, the printing based on this print execution operation is cancelled on the printer.

### SUMMARY

With the above conventional technology, printing may be cancelled despite the user having performed an operation to perform the printing, which may result in a decrease in user convenience.

In view of the foregoing, it is an object of the present disclosure to provide a technology that can prevent a decrease in user convenience in a printing service that permits the printing of the number of sheets on the basis of a payment of a fee.

In order to attain the above and other object, the present disclosure provides a printing system. The printing system includes a management server, and a printer. The management server includes a server controller, and a server memory. The server controller is configured to manage the number of printable sheets based on payments of fees. The printer includes a print engine, a communication interface, a printer memory, and a printer controller. The printer controller is configured to control the print engine to perform printing up to the number of printable sheets indicated by sheet information stored in the printer memory. The server controller is configured to perform: an automated reloading process in a case that a specific condition concerning the number of printable sheets is satisfied while an enabled automated-reloading setting is enabled stored in the server memory, the automated reloading process being to increase the number of printable sheets by requesting completion of a payment process of a fee; and transmitting reloading-result information related to a result of the automated reloading process to the printer. The printer controller is configured to further perform: updating the sheet information on the basis of at least one of the reloading-result information and printing-result information related to a result of printing with the print engine so that the number of printable sheets is increased or decreased; determining whether a permission condition is satisfied, the permission condition including: a condition that the printer is in an online state in which the communication interface is communicably connected to the management server; and a condition that an enabled automated-reloading setting is stored in the printer memory; when the permission condition is satisfied, permitting printing of one or more sheets in excess of the number of printable sheets; and updating the sheet information by counting the number of actually printed sheets that have been printed with the print engine after the permitting, the number of actually printed sheets including an excessive number of sheets printed in excess of the number of printable sheets after the permitting; and when the permission condition is not satisfied, prohibiting the printing of one or more sheets in excess of the number of printable sheets.

According to another aspect, the present disclosure provides a printer. The printer includes a print engine, a communication interface, a memory, and a controller. The controller is configured to control the print engine to perform printing up to the number of printable sheets indicated by sheet information stored in the memory. The controller is configured to further perform: updating sheet information stored in the memory on the basis of at least one of reloading-result information and printing-result information so that the number of printable sheets is increased or decreased, the reloading result information being transmitted from a management server communicably connected to the communication interface and being related to a result of a reloading process to increase the number of printable sheets by requesting completion of a payment process of a fee, the printing-result information being related to a result of printing with the print engine; determining whether a permission condition is satisfied, the permission condition including: a condition that the printer is in an online state in which the communication interface is communicably connected to the management server; and a condition that the enabled automated-reloading setting is stored in the memory; when the permission condition is satisfied, permitting printing of one or more sheets in excess of the number of printable sheets; and updating the sheet information by counting the number of actually printed sheets that have been printed with the print engine after the permitting, the number of actually printed sheets including an excessive number of sheets printed in excess of the number of printable sheets after the permitting; and when the permission condition is not satisfied, prohibiting the printing of one or more sheets in excess of the number of printable sheets.

According to another aspect, the present disclosure provides a printing method using a management server and a printer communicably connected to the management server. The method includes: the management server performing an automated reloading process in a case that a specific condition concerning the number of printable sheets is satisfied while an enabled automated-reloading setting is stored in a server memory provided in the management server, the automated reloading process being to increase the number of printable sheets by requesting completion of a payment process of a fee; the management server transmitting reloading-result information related to a result of the automated reloading process to the printer; the printer updating the sheet information on the basis of at least one of the reloading-result information and printing-result information related to a result of printing with the print engine so that the number of printable sheets is increased or decreased; the printer determining whether a permission condition is satisfied, the permission condition including: a condition that the printer is in an online state in which the printer is communicably connected to the management server; and a condition that an enabled automated-reloading setting is stored in a printer memory provided in a printer; when the permission condition is satisfied, the printer permitting printing of one or more sheets in excess of the number of printable sheets; and the printer updating the sheet information by counting the number of actually printed sheets that have been printed in the printer after the printer permitting, the number of actually printed sheets including an excessive number of sheets printed in excess of the number of printable sheets after the permitting; and when the permission condition is not satisfied, the printer prohibiting the printing of one or more sheets in excess of the number of printable sheets.

In the above structure, printing of sheets exceeding the number of printable sheets is permitted. For example, there may be a case that the number of printable sheets is temporarily insufficient due to the reloading process taking a relatively long time. According to the above structures, printing of sheets exceeding the number of printable sheets is permitted in order to avoid occurrence of such a problem. Accordingly, a decrease in user convenience in a printing service in which the printing of the number of sheets according to the reloading process is allowed. Further, when the above permission condition is satisfied, the number of actually printed sheets including an excessive number of sheets printed in excess of the number of printable sheets is counted to update the sheet information, thereby suppressing inconveniences such as missed billings when printing exceeds the number of printable sheets.

### BRIEF DESCRIPTION OF DRAWINGS

FIG. 1 is a block diagram showing a configuration of a system.

FIG. 2A is tables illustrating a management database stored in a management server.

FIG. 2B is a table illustrating an information database stored in a printer.

FIG. 3 is a sequence chart illustrating a part of a periodic process performed while automated reloading is enabled.

FIG. 4 is a sequence chart illustrating a remaining part of the periodic process.

FIG. 5 is a sequence chart illustrating a payment information updating process.

FIG. 6 is a flowchart illustrating a printing process.

### DESCRIPTION

### A. Embodiment

### A-1. Configuration of a System 1000

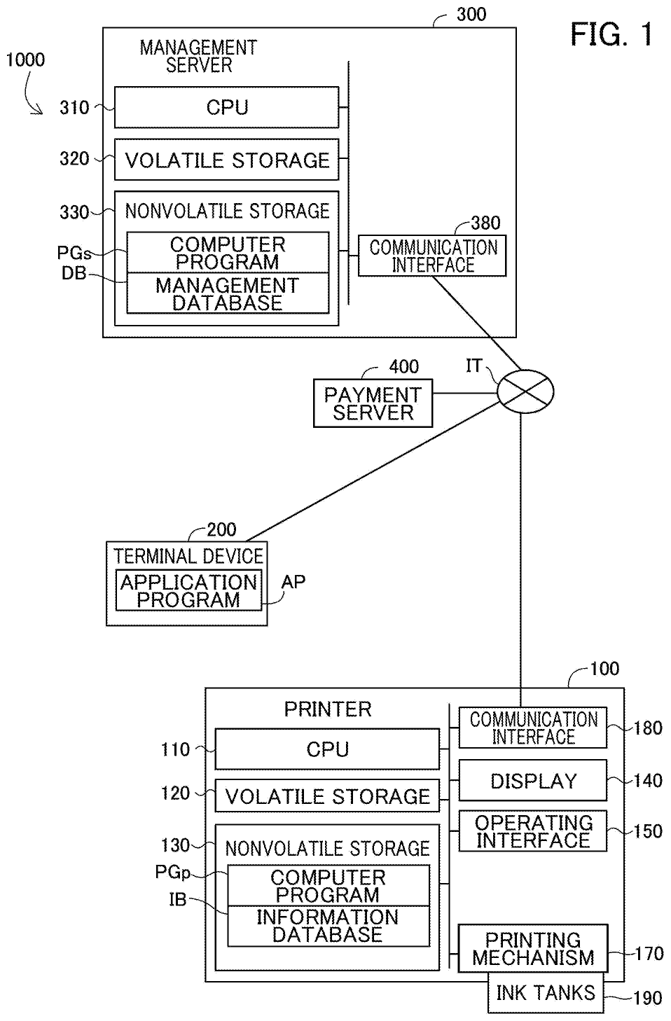

FIG. 1 is a block diagram showing the configuration of a system 1000. The system 1000 is provided with a printer 100, a terminal device 200 owned by the user of the printer 100, a management server 300, and a payment server 400.

The printer 100 uses ink as the printing material. The ink is consumed by printing operation. The printer 100 is provided with a CPU 110 serving as a controller of the printer 100, a volatile storage 120 such as DRAM, and a nonvolatile storage 130 such as a hard disk drive or flash memory. The printer 100 is also provided with a display 140, such as a liquid crystal display, for displaying images; an operating interface 150 including buttons, a touchscreen, and the like for receiving user operations; a printing mechanism 170; and a communication interface 180.

The communication interface 180 is an interface for connecting to an internet IT, such as a wired interface compliant with Ethernet or a wireless interface compliant with the Wi-Fi standard. The communication interface 180 may be a network interface.

The CPU 110 is an arithmetic device (processor) that performs data processing. The volatile storage 120 provides a buffer area for temporarily storing various intermediate data generated when the CPU 110 executes processes. The nonvolatile storage 130 stores a computer program PGp for controlling the printer 100, and an information database IB that records various types of information described later.

In the present embodiment, the computer program PGp is stored in the nonvolatile storage 130 in advance at the time the printer 100 is manufactured. As an alternative, the computer program PGp may be downloaded from a server connected to the printer 100 via the internet IT or may be recorded on a CD-ROM or other storage medium and supplied in this form.

By executing the computer program PGp, the CPU 110 implements various processes for controlling the printer 100. For example, as will be described later in greater detail, the CPU 110 executes a printing process by controlling the printing mechanism 170 to print an image. The CPU 110 also executes various processes related to a printing service in conjunction with the management server 300.

The printing mechanism 170 executes printing under control of the CPU 110. The printing mechanism 170 is an inkjet printing mechanism that prints images on recording media using a plurality of types of ink (e.g., ink in the four colors cyan, magenta, yellow, and black) as the color material. The inks are accommodated in ink tanks 190. As an alternative, the printing mechanism 170 may be an electrophotographic printing mechanism that prints images on recording media using toner accommodated in toner cartridges as the color material. The printing mechanism 170 is an example of a print engine.

The terminal device 200 is a computer that is provided with a CPU, a memory, and a display (e.g., a liquid crystal display) not shown in the drawings. For example, the terminal device 200 may be a smartphone. As a variation, the terminal device 200 may be a personal computer or a tablet computer. The terminal device 200 is provided with a prescribed communication interface (not shown), such as a wireless communication interface compliant with the Wi-Fi standard or a mobile communication standard (e.g., the Long Term Evolution (LTE) standard). An application program AP is installed on the terminal device 200. The application program AP controls the CPU of the terminal device 200 to execute processes related to the printing service. Hereinafter, the CPU of the terminal device 200 controlled by the application program AP will be calleted the “terminal application”. The terminal application executes a process for transmitting user information needed for the printing service to the management server 300, for example. This user information may be payment information, such as the user's credit card number.

The management server 300 is a computer operated by the service provider providing the printing service (e.g., the company that manufactures or sells the printer 100), for example. The management server 300 is a cloud server, for example. The management server 300 is provided with a CPU 310 serving as the controller of the management server 300, a volatile storage 320 such as DRAM, a nonvolatile storage 330 such as a hard disk drive or flash memory, and a communication interface 380. The communication interface 380 is a wired interface compliant with Ethernet, for example.

The CPU 310 is an arithmetic device (a processor) that performs data processing. The volatile storage 320 provides a buffer area for temporarily storing various intermediate data generated when the CPU 310 executes processes. The nonvolatile storage 330 stores a computer program PGs, and a management database DB recording various information described later.

The service provider operating the printing service may provide the computer program PGs in an uploaded form, for example. By executing the computer program PGs, the CPU 310 of the management server 300 implements processes related to the printing service, such as a service modification process or a process for providing the printing service described later.

The payment server 400 is a computer that provides an online payment service. The payment server 400 is a cloud server, for example. As will be described later, the management server 300 uses this online payment service to complete payments for automated reloading.

Although FIG. 1 depicts only one printer 100 and one terminal device 200, the management server 300 provides the printing service to many users using many printers. The various processes of the printing service are described below for a single printer 100 and a single terminal device 200, but these processes are executed independently for each printer being managed.

### A-2. Management Database DB and Information Database IB

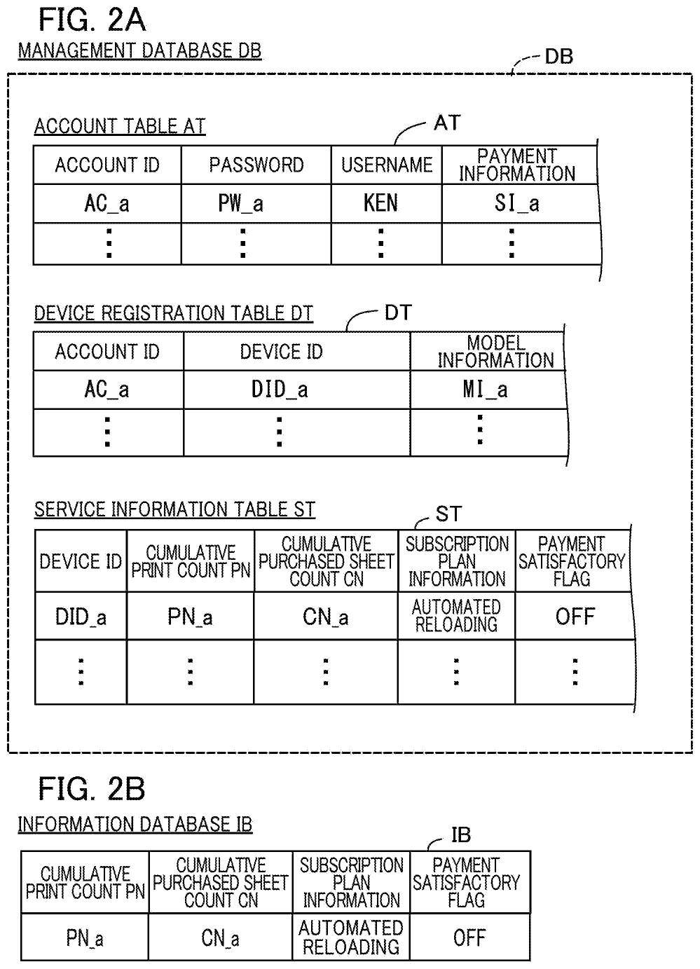

Next, a description will be provided for the management database DB stored in the nonvolatile storage 330 of the management server 300 and the information database IB stored in the nonvolatile storage 130 of the printer 100. FIGS. 2A and 2B are explanatory diagrams for the management database DB and the information database IB respectively. The management database DB shown in FIG. 2A includes an account table AT, a device registration table DT, and a service information table ST.

The account table AT is used to register records of user information for users. Each record of user information includes a user account for a user of the printing service and information related to the account. In the present embodiment, each record of user information includes an account ID, a password, a username, and payment information, as illustrated in FIG. 2. In the example of FIG. 2, a record including the account ID “AC_a”, the password “PW_a”, the username “KEN”, and the payment information “SI_a” is registered for the administrative user of the printer 100. While not shown in the drawing, each record of user information in the account table AT has other types of information for the corresponding user necessary for the printing service. The other types of information include the user's address (a shipping address for ink bottles) and the user's e-mail address, for example. Payment information includes the user's credit card number, for example.

The device registration table DT is used to register records, each including device information associated with an account ID. Device information in each record includes one or more device IDs for identifying one or more devices, model information for the devices, and the like. This table associates the user identified by an account ID with one or more printers used in relation to the printing service. In the example of FIG. 2, the account ID “AC_a” for the user of the printer 100 is recorded in association with the device ID “DID_a” and the model information “MI_a” of the printer 100.

The service information table ST is used to register records of information related to the printing services for printers used in the printing service. Each record in the service information table ST includes a device ID identifying a printer, a cumulative print count PN, a cumulative purchased sheet count CN, subscription plan information, and a payment satisfactory flag in association with each other.

The cumulative print count PN is the cumulative number of sheets that has been printed with a printer (e.g., the printer 100) used with the printing service since the printer was purchased. The cumulative purchased sheet count CN is the cumulative number of sheets that a printer used with the printing service is allowed to perform printing based on the amount of money (fees) that has been paid. The cumulative purchased sheet count CN is increased through payments of fees. The subscription plan information specifies the subscription plan (a reloading method, or a payment method) for the printing service and is either “manual reloading” or “automated reloading” in this embodiment. The manual reloading is a subscription plan in which the user uses the terminal application for accessing the management server 300 to pay for a fee so as to increase (reload) cumulative purchased sheet count CN (the number of printable sheets). The automated reloading is a subscription plan in which the management server 300 automatically conducts a commercial transaction when the number of printable sheets for the printer is smaller than or equal to a reference sheet count, as will be described later. Here, this commercial transaction includes payment of the charged fee without requiring approval of the user so as to increase (reload) the cumulative purchased sheet count CN (the number of printable sheets). In performing the automated reloading, the management server 300 requests, to the server 400, completion of the payment of the charged fee without requiring confirmation or approval of the user to allow the payment server 400 to settle the payment of the fee. In other words, the automated reloading is a process so as to automatically complete payment of the fee to increase the purchased sheet count CN without requiring confirmation or approval of the user while billing the user for the fee. The payment satisfactory flag is set to “ON” when the previous payment made for the user of the printer was completed successfully without any issues and is set to “OFF” when the previous payment for the user failed due to some problem. In the service information table ST of the example in FIG. 2A, the cumulative print count “PN_a”, the cumulative purchased sheet count “CN_a”, subscription plan information indicating “automated reloading”, and a payment satisfactory flag indicating “OFF” are recorded in association with the device ID “DID_a” for the printer 100. This information will be described below in greater detail.

Although not shown in the drawings, each record of the service information table ST has other types of information required for the printing service. The other types of information may include residual ink quantity information for the ink tanks 190, and status information specifying the printer status (normal, error, etc.), for example.

As shown in FIG. 2B, the information database IB of the printer 100 is used to register records. Here, each record in the information database IB includes information for the printing service used with the printer 100, such as, the cumulative print count PN, the cumulative purchased sheet count CN, subscription plan information, and payment satisfactory flag. While not shown in the drawing, as with the service information table ST, each record in the information database IB may include other types of information required for the printing service, such as the residual ink quantity information for the ink tanks 190 and status information specifying the printer status (normal, error, etc.).

### A-3. Overview of the Printing Service

The printing service of the present embodiment uses a pay-as-you-go system. A user who wishes to subscribe to the printing service first purchases a printer 100. The printer 100 includes inks to be supplied to the ink tanks 190. The purchaser of the printer 100 is granted the authorization to print a predetermined initial number of sheets (e.g., 100 sheets). The user sets up the purchased printer 100 so that the printer 100 can connect to the internet IT with the communication interface 180. As a result, the printer 100 can communicate with the management server 300 over the internet IT. While power to the printer 100 is on, the printer 100 and the management server 300 in the present embodiment establish a communication session for an always-on connection according to the Extensible Messaging and Presence Protocol (XMPP). By enabling communication between the printer 100 and the management server 300 using this communication session, the printer 100 and the management server 300 can send data to each other at any time. Hereinafter, the state in which a communication session for an always-on connection has been established between the printer 100 and the management server 300 will be called an online state, and the state in which a communication session for an always-on connection is not established will be called an offline state.

When the printer 100 enters the online state, the printer 100 (the CPU 110) transmits device information to the management server 300. This device information includes a device ID, which is a unique identifier that the CPU 110 assigns the printer 100 in advance. Upon receiving this device information, the management server 300 (the CPU 310) registers a record including this device information in the device registration table DT of the management database DB (see FIG. 2A).

Next, the user starts up the aforementioned terminal application on the terminal device 200. The terminal application transmits user information including the user's account ID together with the device ID of the printer 100 to the management server 300 in response to a user instruction. Upon receiving the user information and the device ID, the management server 300 registers the user information in the account table AT of the management database DB. The management server 300 searches the records already registered in the device registration table DT of the management database DB for the device ID received from the terminal device 200. When the record including the received device ID is found through the searching, the management server 300 registers the account ID received from the terminal device 200 in the found record in the device registration table DT so that the account ID is in association with the received device ID (see FIG. 2A).

The management server 300 also registers, in the service information table ST of the management database DB, a record including the received device ID, the cumulative purchased sheet count CN, cumulative print count PN, subscription plan information, and payment satisfactory flag in association with each other. The cumulative purchased sheet count CN registered at this time is the initial value. For example, the cumulative purchased sheet count CN is the initial number of sheets (described above) that the purchaser of the printer 100 was granted authorization to print. The cumulative print count PN registered at this time is also an initial value, such as 0. The subscription plan information is set to “manual reloading” as the default plan, for example. The payment satisfactory flag is set to “OFF” since no payments have been made at this stage. The management server 300 transmits information specifying the recorded cumulative purchased sheet count CN, subscription plan information, and payment satisfactory flag to the printer 100. Upon receiving this information, the printer 100 registers the cumulative purchased sheet count CN, subscription plan information, and payment satisfactory flag in the information database IB (see FIG. 2(B)). The cumulative print count PN, whose initial value is 0, is prerecorded in the information database IB of the printer 100.

Once the required information has been registered in the management database DB and the information database IB in this way, the printer 100 enters a print ready state. The print ready state is a state in which the printer 100 can perform printing in response to a print instruction from the user. For example, the user inputs a print instruction specifying image data that represents an image to be printed. The printer 100 uses the specified image data to print an image on print media such as paper. A print instruction may also be inputted into the terminal device 200 or another terminal device. In this case, the terminal device 200 transmits a print job including the specified image data and the print instruction to the printer 100. Further, when a USB memory holding the specified image data is inserted into the printer 100, the user may input a print instruction to perform printing based on the specified image data in the USB memory via the operating interface 150 of the printer 100. The printer 100 updates the cumulative print count PN in the information database IB after executing each print. Specifically, the printer 100 adds the number of sheets printed in the latest print to the current cumulative print count PN to update the value of the cumulative print count PN.

The value obtained by subtracting the cumulative print count PN from the cumulative purchased sheet count CN (CN-PN) is the number of sheets that the user can currently print on the printer 100. Hereinafter, this number will be called the “printable sheet count AN” (AN=CN-PN). When the subscription plan is “manual reloading”, the printer 100 switches from the print ready state to a print prohibited state once the printable sheet count AN reaches 0. In the print prohibited state, the printer 100 cannot execute printing even when a print instruction is received from the user or even when a print job is currently in progress. In this case, the printer 100 displays a message on the display 140 indicating that printing cannot be performed because the printable sheet count AN is 0.

When the subscription plan is set to “manual reloading”, the user can increase the cumulative print count PN by sending a reloading request to the management server 300 from the terminal device 200 (the terminal application) either before or after the printer 100 switches to the print prohibited state.

Upon receiving the reloading request, the management server 300 executes a reloading process for incrementing the cumulative purchased sheet count CN by the number of requested sheets in the reloading request. The management server 300 transmits a payment request for completing payment of the fee for incrementing the cumulative purchased sheet count CN by the number of requested sheets to the payment server 400 using the payment information (e.g., the credit card number) included in the user information recorded in the account table AT. In response to this payment request, the payment server 400 executes a well-known online payment process and returns a payment complete notification to the management server 300 when the payment process was successful. When a payment complete notification is received, the management server 300 adds the requested number of sheets just purchased to the cumulative purchased sheet count CN in the service information table ST of the management database DB associated with the device ID of the printer 100. The management server 300 then notifies the printer 100 of the new cumulative purchased sheet count CN. Upon receiving this notification, the printer 100 updates the cumulative purchased sheet count CN recorded in the information database IB to be equal to the cumulative purchased sheet count CN in the service information table ST in the management server 300. As a result of this process, the cumulative purchased sheet count CN recorded on the printer 100 is increased by the number of requested sheets just purchased, thereby increasing the printable sheet count AN by the same number of purchased sheets.

When the printer 100 is in the online state, the printer 100 periodically transmits a notification (a periodic notification) that includes various information on the printer 100 to the management server 300. The printer 100 transmits a periodic notification every minute in the present embodiment. A periodic notification includes the cumulative print count PN, information indicating the residual quantities of inks in the printer 100, and status information for the printer 100, for example. The status information may include information on failures indicating whether the printer 100 malfunctions. Upon receiving a periodic notification, the management server 300 updates various information in the service information table ST of the management database DB (e.g., the cumulative print count PN) associated with the device ID of the printer 100.

Since the printing service in the present embodiment employs a pay-as-you-go system in which fees are payed on the basis of the number of printed sheets, the service provider operating the printing service supplies inks to the user free of charge. For enabling this service, the management server 300 manages the residual quantities of inks in the printer 100 based on the information included in the periodic notifications that specify the residual ink quantities and performs a process to ship ink bottles to the user when the residual ink quantities drop below a threshold quantity. The service provider also repairs or replaces the printer 100 free of charge when the printer 100 malfunctions. The management server 300 manages the occurrence and extent of any malfunctions on the printer 100 based on information on failures included in the periodic notifications and performs a process to ship a replacement printer 100 to the user as needed. Because these processes have little connection to the present disclosure, a detailed description of the processes has been omitted.

### A-4. Operations During Automated Reloading

An overview of the printing service was described above for a case in which the subscription plan is set to “manual reloading.” However, with the printing service of the present embodiment, the user can select “automated reloading” as the subscription plan. The user inputs an instruction to change the subscription plan for the printer 100 from “manual reloading” to “automated reloading” through operations on the terminal device 200 (the terminal application), for example. When acquiring the instruction to change the subscription plan, the terminal application transmits a change request to the management server 300 requesting the subscription plan for the printer 100 be changed from “manual reloading” to “automated reloading.” Upon receiving this change request, the management server 300 changes the subscription plan information associated with the device ID for the printer 100 in the service information table ST of the management database DB (see FIG. 2(A)) from information specifying “manual reloading” to information specifying “automated reloading”. Thereafter, the management server 300 transmits a change notification to the printer 100 indicating that the subscription plan has been changed to “automated reloading”. After receiving the change notification, the printer 100 modifies the subscription plan information registered in the information database IB (see FIG. 2(B)) from information specifying “manual reloading” to information specifying “automated reloading”. Thereafter, automated reloading is enabled. As will be described below, when the printable sheet count AN drops below a reference sheet count THc during automated reloading according to the present embodiment, the management server 300 initiate a transaction to settle payment of a printing fee for a predetermined number of sheets (several tens of sheets to several thousands of sheets, for example) without first confirming with the user of the printer 100 and adds this predetermined number of purchased sheets to the cumulative purchased sheet count CN. The reference sheet count THc is an integer greater than or equal to 0, such as several sheets to several tens of sheets.

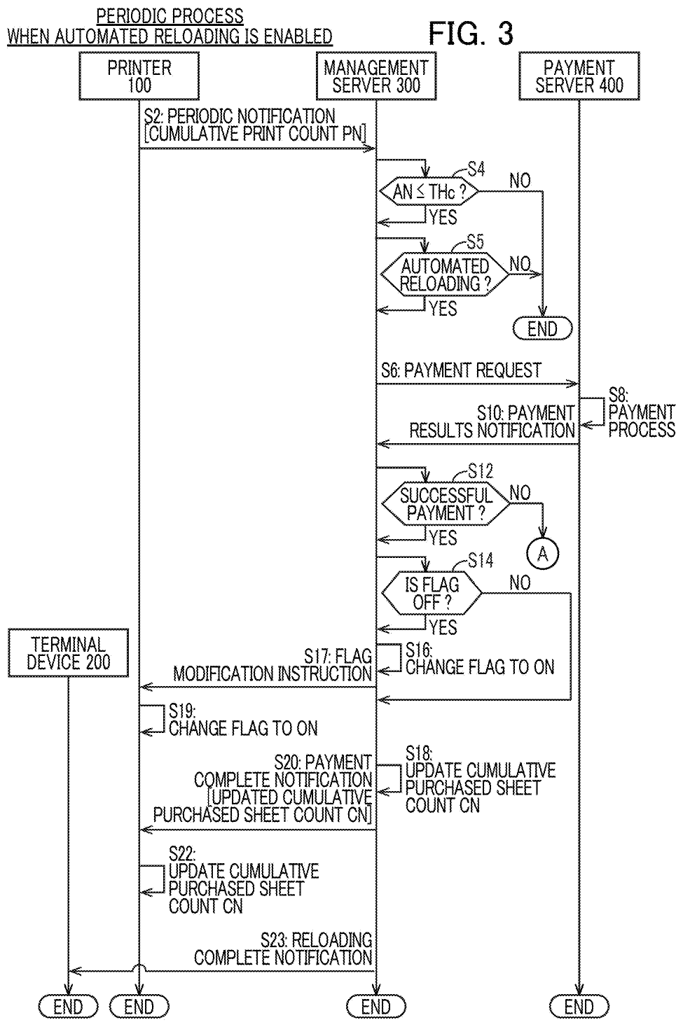

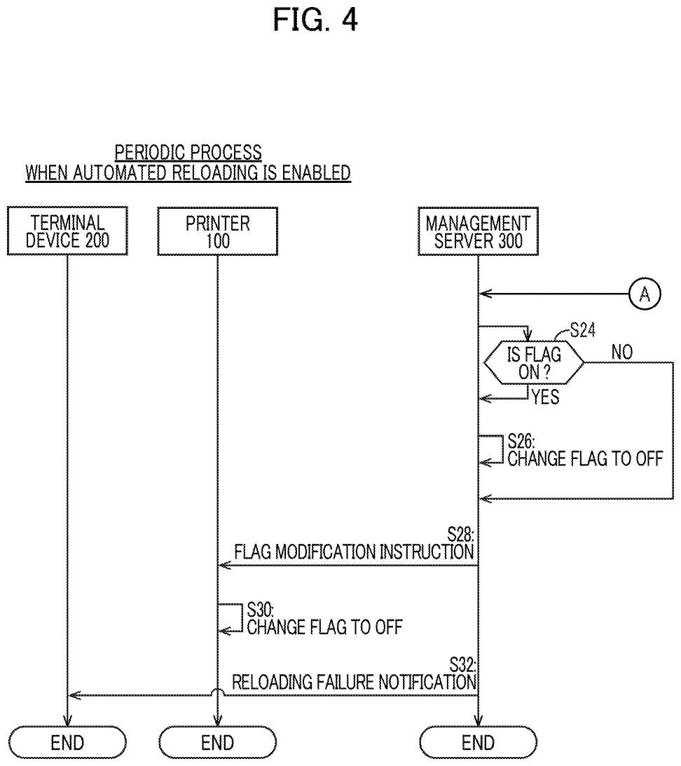

FIGS. 3 and 4 are sequence charts for a periodic process performed while automated reloading is enabled. The process in FIGS. 3 and 4 begins at the timing of each periodic notification described above. While the periodic process includes various processes, such as the management of residual ink quantities and the shipment of ink bottles, a description of such processes has been omitted here because they have little relevance to the present invention. Only processes related to payment in automated reloading are described below and illustrated in the drawings.

At the timing of each periodic notification, in S2 of FIG. 3, the printer 100 transmits information specifying the cumulative print count PN to the management server 300 as the periodic notification. As described above, the cumulative print count PN is registered in the information database IB shown in FIG. 2B.

When the management server 300 (the CPU 310) receives information specifying the cumulative print count PN, in S4 the management server 300 determines whether the printable sheet count AN is less than or equal to the reference sheet count THc. Specifically, the management server 300 updates the cumulative print count PN in the service information table ST (see FIG. 2(A)) with the cumulative print count PN received from the printer 100 and calculates the current printable sheet count AN using the updated cumulative print count PN and the cumulative purchased sheet count CN (AN=CN−PN). The management server 300 then determines whether this calculated printable sheet count AN is less than or equal to the reference sheet count THc.

When the printable sheet count AN is less than or equal to the reference sheet count THc (S4: YES), in S5 the management server 300 determines whether the subscription plan for the printer 100 is “automated reloading” by referencing the subscription plan information for the printer 100 registered in the service information table ST.

When the subscription plan for the printer 100 is “automated reloading” (S5: YES), the management server 300 advances to S6 in order to perform automated reloading. However, when the printable sheet count AN is greater than the reference sheet count THc (S4: NO) or when the subscription plan for the printer 100 is set to “manual reloading” (S5: NO), the management server 300 ends the process in FIG. 3 because there is no need to perform automated reloading.

In S6 the management server 300 transmits a payment request to the payment server 400 requesting payment for the predetermined number of requested sheets. The payment request includes the username and payment information (e.g., a credit card number) recorded in the account table AT for the printer 100, for example. Upon receiving the payment request, in S8 the payment server 400 executes a payment process. In S10 the payment server 400 transmits a payment results notification to the management server 300 indicating the results of the payment process. The payment results notification indicates whether the payment process was completed successfully.

Upon receiving the payment results notification, in S12 the management server 300 references the payment results notification to determine whether payment for the predetermined number of requested sheets was settled successfully. When the payment was completed successfully (S12: YES), in S14 the management server 300 determines whether the payment satisfactory flag recorded in the service information table ST is set to “OFF”.

When the payment satisfactory flag is OFF (S14: YES), in S16 the management server 300 change the payment satisfactory flag recorded in the service information table ST to “ON”. In S17 the management server 300 transmits a flag modification instruction to the printer 100 instructing the printer 100 to change the payment satisfactory flag to “ON”. When receiving a flag modification instruction, in S19 the printer 100 changes the payment satisfactory flag recorded in the information database IB to “ON”.

When the payment satisfactory flag recorded in the service information table ST is already ON (S14: NO), the management server 300 skips steps S16 and S17. Accordingly, the printer 100 does not execute the process in S19 to change the payment satisfactory flag.

In S18 the management server 300 updates the cumulative purchased sheet count CN for the printer 100 registered in the service information table ST. The management server 300 updates the cumulative purchased sheet count CN by adding the predetermined number of requested sheets, for which payment was just completed, to the current cumulative purchased sheet count CN. In S20 the management server 300 then transmits a payment complete notification to the printer 100. The payment complete notification includes information specifying the updated cumulative purchased sheet count CN. Upon receiving the payment complete notification, in S22 the printer 100 updates the cumulative purchased sheet count CN recorded in the information database IB to the value specified by the information included in the payment complete notification.

In S23 the management server 300 transmits a reloading complete notification to the terminal device 200. The reloading complete notification is sent through a push notification addressed to the terminal application, for example. The push notification is sent using a well-known push notification service such as Firebase Cloud Messaging (FCM). The user can determine that a payment for automated reloading was made and that the cumulative purchased sheet count CN has been increased through this automated reloading when the user starts up the terminal application to check the push notification, for example.

When the payment was not completed successfully (S12: NO), the management server 300 advances to S24 of FIG. 4. Possible reasons for a payment not being completed successfully include an error in the payment information, the payment server 400 rejecting the payment due to the credit card specified in the payment information being expired or the like, or the payment server 400 being down.

In S24 the management server 300 determines whether the payment satisfactory flag registered in the service information table ST is set to “ON”. When the payment satisfactory flag is ON (S24: YES), in S26 the management server 300 changes the payment satisfactory flag recorded in the service information table ST to “OFF”. In S28 the management server 300 transmits a flag modification instruction to the printer 100 instructing the printer 100 to change the payment satisfactory flag to “OFF”. Upon receiving the flag modification instruction, in S30 the printer 100 changes the payment satisfactory flag recorded in the information database IB to “OFF”.

When the payment satisfactory flag in the service information table ST is already OFF (S24: NO), the management server 300 skips steps S26 and S28. Accordingly, the printer 100 does not execute the process in S30 to change the payment satisfactory flag.

In S32 the management server 300 transmits a reloading failure notification to the terminal device 200. The reloading failure notification may be transmitted through a push notification addressed to the terminal application, for example. The user can see that the automated reloading was unsuccessful by starting up the terminal application and checking the push notification, for example. The user can then take measures to ensure that the next payment in automated reloading is successful by updating the user's payment information, as will be described next.

As described above, the payment satisfactory flag for the printer 100 is set to “ON” when the last payment in automated reloading for the printer 100 was completed successfully and is set to “OFF” when the last payment was not completed successfully.

### A-5. Payment Information Updating Process

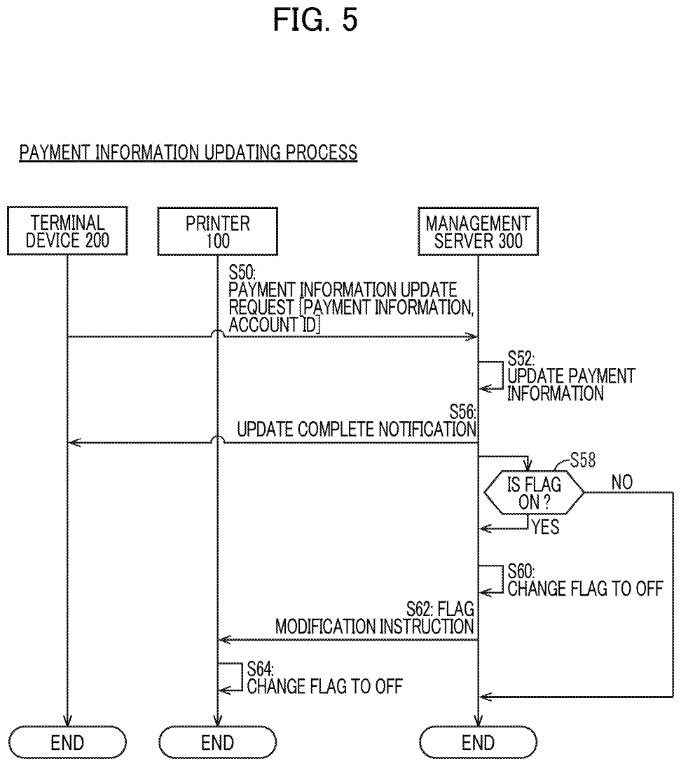

FIG. 5 is a sequence chart for a payment information updating process. The payment information updating process is performed to update payment information in response to a user instruction. To update the payment information (e.g., a credit card number or expiration date of the credit card), the user operates the terminal device 200 to log in to the user's account in the terminal application, enters new payment information in a prescribed entry screen of the terminal application (not shown), and then enters an update instruction.

When the terminal device 200 (the terminal application) acquires an update instruction for payment information, in S50 the terminal device 200 transmits a payment information update request to the management server 300. The payment information update request includes the payment information inputted into the entry screen and the account ID for the user. Upon receiving a payment information update request, in S52 the management server 300 updates the user's payment information recorded in the account table AT of the management database DB (see FIG. 2(A)). That is, the management server 300 modifies the payment information in the account table AT associated with the account ID included in the payment information update request to the payment information included in the payment information update request. In S56 the management server 300 transmits an update complete notification to the terminal device 200 indicating that the user's payment information was updated.

In S58 the management server 300 determines whether the payment satisfactory flag recorded in the service information table ST of the management database DB is set to “ON”. When the payment satisfactory flag is ON (S58: YES), in S60 the management server 300 changes the payment satisfactory flag recorded in the service information table ST to “OFF”. In S62 the management server 300 transmits a flag modification instruction to the printer 100 instructing the printer 100 to change the payment satisfactory flag to “OFF”. Upon receiving this flag modification instruction, in S64 the printer 100 changes the payment satisfactory flag recorded in the information database IB to “OFF”.

When the payment satisfactory flag recorded in the service information table ST of the management database DB is “OFF” (S58: NO), the management server 300 skips steps S60 and S62. Accordingly, the printer 100 does not execute the process in S64 for modifying the payment satisfactory flag.

As is clear from the above description, when payment information for the user of the printer 100 has been updated, the payment satisfactory flag for the printer 100 is temporarily set to “OFF”, even when the last payment performed in automated reloading for the printer 100 was successful. When a payment for automated reloading is subsequently successful, the payment satisfactory flag is then changed from “OFF” to “ON”, as described above in the periodic process (see S12-S19 of FIG. 3).

### A-6. Printing Process

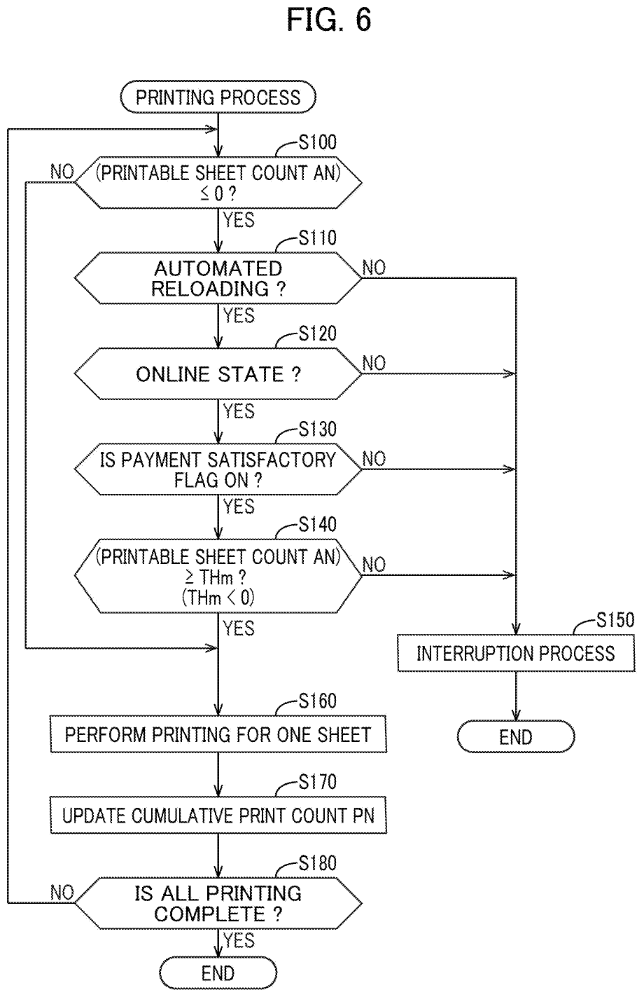

Next, a printing process executed by a printer 100 (CPU 110) used with the printing service will be described. FIG. 6 is a flowchart showing steps in the printing process. The printer 100 executes the printing process when a print job based on a user instruction is received from the terminal application or when the user inputs a print instruction via the operating interface 150 of the printer 100, for example.

In S100 of FIG. 6, the printer 100 determines whether the printable sheet count AN is less than or equal to 0. When the printable sheet count AN is greater than 0 (S100: NO), the printer 100 perform printing for one sheet in S160. For example, the printer 100 interprets the received print job, generates print data for one sheet, and controls the printing mechanism 170 to perform printing based on this print data. In S170 the printer 100 updates the cumulative print count PN recorded in the information database IB. That is, the printer 100 increments the cumulative print count PN by 1. This causes the printable sheet count AN to decrease by 1.

However, when the printable sheet count AN is less than or equal to 0 (S100: YES), in S110 the printer 100 references the subscription plan information recorded in the information database IB (see FIG. 2B) to determine whether the subscription plan is “automated reloading”.

When the subscription plan is “manual reloading” (S110: NO), in S150 the printer 100 executes an interruption process. For example, the printer 100 displays, on the display 140, a notification screen indicating that printing is not possible because the printable sheet count AN is insufficient and interrupts the printing process. Hence, in a case that the subscription plan is set to “manual reloading” in the present embodiment, printing is not permitted when the printable sheet count AN is 0 or less.

When the subscription plan is “automated reloading” (S110: YES), in S120 the printer 100 determines whether the state of communication between the printer 100 and the management server 300 is the online state. For example, the printer 100 determines that the communication state is the online state when the last periodic communication with the management server 300 was successful and determines that the communication state is the offline state when the last periodic communication was unsuccessful. Alternatively, the printer 100 may transmit a confirmation signal to the management server 300 and may determine that the communication state is the online state when a response signal is received from the management server 300 within a prescribed period (e.g., a few seconds) and may determine that the communication state is the offline state when a response signal is not received from the management server 300 within the prescribed period.

When the communication state between the printer 100 and the management server 300 is the offline state (S120: NO), the printer 100 executes the interruption process in S150 described above. Thus, even in a case that the subscription plan is set to “automated reloading” in the present embodiment, printing is not allowed when the communication state with the management server 300 is the offline state and the printable sheet count AN is less than or equal to 0.

However, when the communication state between the printer 100 and the management server 300 is the online state (S120: YES), in S130 the printer 100 determines whether the payment satisfactory flag recorded in the information database IB (see FIG. 2(B)) is set to “ON”. In other words, the printer 100 determines whether the last payment for a fee was settled successfully.

When the payment satisfactory flag is “OFF” (S130: NO), the printer 100 executes the interruption process in S150. Thus, even in a case that the subscription plan is set to “automated reloading” in the present embodiment, printing is not allowed when the last payment for fee failed and the printable sheet count AN is less than or equal to 0.

However, when the payment satisfactory flag is “ON” (S130: YES), in S140 the printer 100 determines whether the printable sheet count AN is greater than or equal to a predetermined threshold value THm (AN≥THm, where AN≤0). Here, the predetermined threshold value THm is a negative integer such as −10 (THm<0). In other words, the printer 100 determines whether the number of sheets printed in excess of the printable sheet count AN is less than or equal to a predetermined allowable number of sheets. Here, because the printable sheet count AN is zero or a negative value, the number of sheets printed in excess of the printable sheet count AN is equal to the absolute value of the printable sheet count AN, and the predetermined allowable number of sheets is equal to the absolute value of the threshold value THm. So, in S140 the printer 100 may determine whether an inequality |AN|≤|THm| is met.

When the printable sheet count AN is less than the threshold value THm (S140: NO), the printer 100 executes the interruption process in S150. Thus, even in a case that the subscription plan is set to “automated reloading” in the present embodiment, the number of sheets that can be printed in excess of the printable sheet count AN is limited to the predetermined number of allowable sheets.

However, when the printable sheet count AN is greater than or equal to the threshold value THm (S140: YES), the printer 100 perform printing for one sheet in S160. In this case, the printable sheet count AN is allowed to become a negative value. In other words, printing in excess of the printable sheet count AN is allowed. The printer 100 permits printing of the number of sheets in excess of the printable sheet count AN up to the predetermined allowable number of sheets (|THm|).

In S170 the printer 100 updates the cumulative print count PN registered in the information database IB. That is, the printer 100 increments the cumulative print count PN by 1. In other words, the printer 100 counts the number of printed sheets including the number of sheets printed in excess of the printable sheet count AN as the cumulative print count PN, causing the printable sheet count AN to become a negative value.

In S180 the printer 100 determines whether all printing is complete. For example, the printer 100 determines whether all printing based on the received print job was completed. When printing is not completed, that is, there is an unprinted page or image to be printed in a sheet (S180: NO), the printer 100 returns to S100. Once all printing is completed (S180: YES), the printer 100 ends the printing process.

As is clear from the above description, all five of the following permission conditions (1)-(5) must be satisfied in the present embodiment to permit printing that exceeds the printable sheet count AN.
(1) Automated reloading is enabled (the subscription plan information indicates “automated reloading”)
(2) An online state is established with the management server 300
(3) The last payment for fee was successfully settled (the payment satisfactory flag is ON)
(4) The number of sheets printed in excess of the printable sheet count AN is no greater than the predetermined number of allowable sheets
(5) At least one payment using the new payment information was settled successfully after the payment information was updated (the payment satisfactory flag is ON)

The condition (3) may be that the last automated reloading was settled successfully settled, and the condition (5) may be that the payment information is not changed after the last automated reloading was settled.

According to the embodiment described above, the management server 300 that manages the number of printable sheets corresponding to payments for fees executes automated reloading based on the printable sheet count AN (S6, S10, and S18 of FIG. 3) when automated reloading is enabled (S5: YES in FIG. 3) and transmits payment-related information (a payment complete notification and a flag modification instruction in this embodiment) to the printer 100 after automated reloading is executed (S20 of FIG. 3). The printer 100, which is connected to and capable of communicating with the management server 300, stores information on sheet counts related to the printable sheet count AN (the cumulative purchased sheet count CN and cumulative print count PN in this embodiment) and information specifying whether automated reloading is enabled (the subscription plan information in this embodiment) in the information database IB (see FIG. 2B). The printer 100 updates the sheet count information (S22 of FIGS. 3 and S170 of FIG. 6) based on purchased-sheet related information (the payment complete notification) received from the management server 300 and actual printing results performed by the printer 100 (the cumulative print count PN in this embodiment). The printer 100 determines whether the printer 100 is in an online state capable of communicating with the management server 300 and whether the above permission conditions including automated reloading being enabled have been met (S110-S140 of FIG. 6). When all the above permission conditions are met (YES determinations for all of S110-S140 in FIG. 6), the printer 100 permits the printing of sheets exceeding the printable sheet count AN (S160 of FIG. 6). When at least one of the above permission conditions is not met (a NO determination in any of S110-S140 in FIG. 6), the printer 100 does not permit printing that exceeds the printable sheet count AN (S150 of FIG. 6). When all the above permission conditions are met, the printer 100 counts the number of printed sheets including the sheets printed in excess of the printable sheet count AN and updates the cumulative print count PN (S170 of FIG. 6).

In a case that the printable sheet count AN is temporarily insufficient due to the process for the payment taking a relatively long time, the printer 100 permits printing of a certain number of sheets exceeding the printable sheet count AN, for example. Therefore, the system of the embodiment can suppress a decrease in user convenience in a printing service in which the printing of the number of sheets corresponding to paid fees is allowed. Further, when all the above permission conditions are met, the printer 100 counts the number of printed sheets including the number printed in excess of the printable sheet count AN and updates the cumulative print count PN accordingly, thereby suppressing inconveniences such as missed billings when printing exceeds the printable sheet count AN, for example.

As an example, assume that the reference sheet count THc for determining when to perform automated reloading is 10 sheets and the management server 300 performs automated reloading when the printable sheet count AN drops to 10 sheets or below. Next, sample operations will be described for this case when the printer 100 receives a print job for printing 30 sheets while the printable sheet count AN is 20 sheets.

After the printer 100 begins printing in this case, the printable sheet count AN reaches 10 sheets once the printer 100 has printed 10 sheets. On the next periodic notification following this timing (S2 in FIG. 3), the management server 300 recognizes that the printable sheet count AN for the printer 100 has dropped to 10 sheets or below, performs a process for automated reloading, and increases the cumulative purchased sheet count CN and printable sheet count AN (S4-S22 of FIG. 3). Here, a certain amount of time is required to perform the payment process on the payment server 400 (S8 in FIG. 3), communication between the printer 100 and the management server 300, and communication between the management server 300 and the payment server 400. The amount of time required varies according to the processing status of the payment server 400 (e.g., the degree of congestion) and the communication load. In some cases, a relatively long time may be required to increase the printable sheet count AN after the printable sheet count AN has dropped to 10 sheets or fewer. In such cases, the printer 100 continues to print, and the printable sheet count AN reaches 0 after a total of 20 sheets have been printed.

It could happen that after the printable sheet count AN has reached 0, the payment process for automated reloading is not completed and, hence, the cumulative purchased sheet count CN and printable sheet count AN are not increased. In such a case, it is conceivable that printing may be interrupted in the middle of the print job if printing more sheets than the printable sheet count AN would not permitted. Because printing the number of sheets exceeding the printable sheet count AN is allowed in the present embodiment when all the above permission conditions (1)-(5) are met, this embodiment can suppress a decrease in user convenience in a printing service employing automated reloading. With automated reloading in particular, the user is often unaware of the printable sheet count AN while using the printing service, and the user could be greatly inconvenienced if printing were to be suddenly interrupted. The system according to the embodiment suppresses such inconveniences to the user.

Further, the permission conditions for permitting printing beyond the printable sheet count AN in the present embodiment include the condition that the printer 100 and the management server 300 are in an online state. This suppresses the occurrence of situations in which the management server 300 cannot ascertain the number of sheets printed beyond the printable sheet count AN, for example. Thus, this condition can suppress inconveniences to the service provider for being unable to collect the fee for the number of sheets printed beyond the printable sheet count AN.

The permission conditions for permitting printing beyond the printable sheet count AN in the present embodiment further include the condition that the number of printed sheets in excess of the printable sheet count AN is no greater than a predetermined number of allowable sheets (S140 of FIG. 6). Because the fee for printing the number of sheets in excess of the printable sheet count AN may be temporarily uncollected, the system of the embodiment can prevent the printing of sheets of a number that greatly exceeds the printable sheet count AN. Therefore, the embodiment can more effectively mitigate the amount of uncollected fees for sheets in excess of the printable sheet count AN.

The permission conditions for permitting the printing of sheets exceeding the printable sheet count AN according to the embodiment further include the condition that at least the last payment for fee was settled successfully (S12 and S16-S19 of FIG. 3, S26-S30 of FIG. 4, and S130 of FIG. 6). When the last payment of fee was settled successfully, fees for printing sheets exceeding the printable sheet count AN are likely to be collected in a subsequent settlement, even if temporarily uncollected. Hence, the possibility of failing the payment of fees for sheets printed beyond the printable sheet count AN can be reduced by including the condition that the last payment for fee was successful in the permission conditions for allowing printing beyond the printable sheet count AN. Therefore, this condition can more effectively suppress the problem of not collecting a fee for printed sheets that exceed the printable sheet count AN.

The permission conditions according to the embodiment further include the condition that payment of the automated reloading was completed successfully after updating the payment information used for payments (S12 and S16-S19 of FIG. 3, S52-S64 of FIG. 5, S26-S30 of FIG. 4, and S130 of FIG. 6). There is a possibility that settlement of payments using payment information may end in failure when the payment information has yet to be used successfully. In order to address such a problem, the condition that a payment using the updated payment information be successful after the payment information has been updated is included as a permission condition. Including this condition can reduce the possibility of failure payment of a fee for sheets printed in excess the printable sheet count AN. Therefore, this condition can more effectively suppress the problem of being unable to collect the fee for the number of sheets printed in excess of the printable sheet count AN.

The automated reloading according to the embodiment is a process in which the management server 300 bills the user for a predetermined number of sheets and performs the process for settling the fee when the printable sheet count AN becomes less than or equal to the reference sheet count THc, without first confirming with the user (S4-S10 of FIG. 3). Such automated reloading provides an advantage to the user since the user can perform printing at any time without being conscious of the printable sheet count AN. Permitting printing of the number of sheets over the printable sheet count AN as described in the embodiment can prevent printing from being interrupted, thereby suppressing the loss of the above-mentioned advantage in automated reloading and, thus, suppressing a decrease in user convenience in the printing service.

In the above embodiment, the management server 300 also notifies the user's terminal device 200 of the results of an automated reloading (S23 of FIGS. 3 and S32 of FIG. 4). Thus, the user of the printer 100 can learn the results of an automated reloading and can take action in the event of a payment failure that could prevent printing from being executed, for example.

Sheet count information managed by the management server 300 and the printer 100 according to the embodiment includes the cumulative purchased sheet count CN and the cumulative print count PN. The printable sheet count AN is obtained by subtracting the cumulative print count PN from the cumulative purchased sheet count CN. With this configuration, the printable sheet count AN can be managed indirectly by managing the cumulative purchased sheet count CN and the cumulative print count PN.

As is clear from the above description, the subscription plan information of the embodiment is an example of an effective information, the cumulative purchased sheet count CN is an example of a first value, the cumulative print count PN is an example of a second value, and the cumulative purchased sheet count CN and cumulative print count PN are examples of sheet count information.

### B. Variations of the Embodiment

(I) The permission conditions in the embodiment include the above conditions (1)-(5), but this is just one example and the conditions may be modified as needed. For example, the permission conditions need not include some or all of the conditions (3)-(5). The permission conditions may include other conditions in place of some or all of conditions (3)-(5) or in addition to conditions (1)-(5). For example, the permission conditions may include a condition that the user has used the printing service for a period greater than or equal to a predetermined reference period and a condition that the cumulative payment amount (the cumulative fees that have been paid) is greater than or equal to a reference payment amount. As another example, the permission conditions may include a condition that the number of successful payment processes settled based on the user's payment information is at least a predetermined count and a condition that the number of failed payment processes is no greater than a predetermined number.
(II) Automated reloading according to the above embodiment is a process in which the management server 300 performs a reloading process to increase the number of purchased sheets by a predetermined number of sheets and pays the fee therefor when the printable sheet count AN becomes less than or equal to the reference sheet count THc, without first confirming with the user. However, other forms of automated reloading may be employed. For example, automated reloading may be a process in which the fees are paid at predetermined intervals (e.g., monthly) for the number of sheets printed during the predetermined interval, without confirming with the user. In this case, when printing the number of sheets that exceeds the printable sheet count AN, the management server 300 may execute an additional reloading process immediately following the printing process that is separate from the normal automated reloading process performed at the predetermined intervals, for example.
(III) In the above embodiment, the management server 300 and the printer 100 manage the cumulative purchased sheet count CN and the cumulative print count PN in databases, while the printable sheet count AN is calculated from the cumulative purchased sheet count CN and the cumulative print count PN. As an alternative, the management server 300 and the printer 100 may calculate the printable sheet count AN and record the printable sheet count AN in the management database DB and the information database IB.
(IV) In the above embodiment, the allowable number of sheets, which the printer 100 permits to print, in excess of the printable sheet count AN (i.e., the absolute value of the threshold value THm) is fixed. However, this allowable number of sheets may be set dynamically on the basis of the length of time that the user has used the printing service or an evaluation value for payment reliability, for example. Alternatively, the allowable number of sheets may be set to a numerical value within a predetermined range according to a user instruction inputted via the operating interface 150, for example.
(V) While the printing service is provided by the single management server 300 in the above embodiment, two or more servers capable of communicating with each other may share responsibilities in providing the printing service. For example, the printing service may be provided by an account management server that manages the account table AT, and a device management server that manages the device registration table DT and the service information table ST. In this case, the account management server may perform communication with the terminal device 200 and the communication with the payment server 400, while the device management server may perform communication with the payment server 400.
(VI) In the embodiment described above, part of the configuration implemented in hardware may be replaced with software and, conversely, all or part of the configuration implemented in software may be replaced with hardware.

While the disclosure has been described in detail with reference to a specific embodiment and variations thereof, the above descriptions are intended to facilitate understanding of the present invention and are not intended to limit the present invention. The present invention may be modified and improved without departing from the spirit of the invention and the scope of the claims and includes equivalents thereof.

What is claimed is:

1. A printing system comprising:
a management server including:
a server controller configured to manage the number of printable sheets based on payments of fees; and
a server memory; and
a printer including:
a print engine;
a communication interface;
a printer memory; and
a printer controller configured to control the print engine to perform printing up to the number of printable sheets indicated by sheet information stored in the printer memory; and
wherein the server controller is configured to perform:
an automated reloading process in a case that a specific condition concerning the number of printable sheets is satisfied while an enabled automated-reloading setting is stored in the server memory, the automated reloading process being to increase the number of printable sheets by requesting completion of a payment process of a fee; and
transmitting reloading-result information related to a result of the automated reloading process to the printer,
wherein the printer controller is configured to further perform:
updating the sheet information on the basis of at least one of the reloading-result information and printing-result information related to a result of printing with the print engine so that the number of printable sheets is increased or decreased;
determining whether a permission condition is satisfied, the permission condition including: a condition that the printer is in an online state in which the communication interface is communicably connected to the management server; and a condition that an enabled automated-reloading setting is stored in the printer memory;
when the permission condition is satisfied,
permitting printing of one or more sheets in excess of the number of printable sheets; and
updating the sheet information by counting the number of actually printed sheets that have been printed with the print engine after the permitting, the number of actually printed sheets including an excessive number of sheets printed in excess of the number of printable sheets after the permitting; and
when the permission condition is not satisfied, prohibiting the printing of one or more sheets in excess of the number of printable sheets.

2. The printing system according to claim 1, wherein the permission condition further includes a condition that an estimated number of sheets is smaller than or equal to a predetermined allowable number, the estimated number of sheets being the number of sheets to be printed in excess of the number of printable sheets.

3. The printing system according to claim 1, wherein the permission condition further includes a condition that last payment of a fee for increasing the number of printable sheets has been completed successfully.

4. The printing system according to claim 1, wherein the server controller is configured to perform the automated reloading process using payment information,
wherein the server controller is configured to perform:
updating the payment information,
wherein the permission condition further includes a condition that after the updating the payment information, the updated payment information has been used for successful payment of a fee for increasing the number of printable sheets.

5. The printing system according to claim 1, wherein in the automated reloading process the server controller requests completion of the payment process of a fee for a predetermined number of sheets without requiring confirmation by a user of the printer.

6. The printing system according to claim 1, wherein the server controller is configured to further perform:
transmitting a notification of a result of the automated reloading process to a terminal device of a user of the printer.

7. The printing system according to claim 1, wherein the sheet information includes a first value and a second value, the first value being an accumulated number of sheets for which fees have been paid, the second value being an accumulated number of sheets that have been printed with the print engine,
wherein the number of printable sheets is a difference of the second value from the first value.

8. A printer comprising:
a print engine;
a communication interface;
a memory; and
a controller configured to control the print engine to perform printing up to the number of printable sheets indicated by sheet information stored in the memory,
wherein the controller is configured to further perform:
updating sheet information stored in the memory on the basis of at least one of reloading-result information and printing-result information so that the number of printable sheets is increased or decreased, the reloading result information being transmitted from a management server communicably connected to the communication interface and being related to a result of a reloading process to increase the number of printable sheets by requesting completion of a payment process of a fee, the printing-result information being related to a result of printing with the print engine;
determining whether a permission condition is satisfied, the permission condition including: a condition that the printer is in an online state in which the communication interface is communicably connected to the management server; and a condition that the enabled automated-reloading setting is stored in the memory;
when the permission condition is satisfied,
permitting printing of one or more sheets in excess of the number of printable sheets; and
updating the sheet information by counting the number of actually printed sheets that have been printed with the print engine after the permitting, the number of actually printed sheets including an excessive number of sheets printed in excess of the number of printable sheets after the permitting; and
when the permission condition is not satisfied, prohibiting the printing of one or more sheets in excess of the number of printable sheets.

9. A printing method using a management server and a printer communicably connected to the management server, the method comprising:
the management server performing an automated reloading process in a case that a specific condition concerning the number of printable sheets is satisfied while an enabled automated-reloading setting is stored in a server memory provided in the management server, the automated reloading process being to increase the number of printable sheets by requesting completion of a payment process of a fee;
the management server transmitting reloading-result information related to a result of the automated reloading process to the printer;
the printer updating the sheet information on the basis of at least one of the reloading-result information and printing-result information related to a result of printing with the print engine so that the number of printable sheets is increased or decreased;
the printer determining whether a permission condition is satisfied, the permission condition including: a condition that the printer is in an online state in which the printer is communicably connected to the management server; and a condition that an enabled automated-reloading setting is stored in a printer memory provided in a printer;
when the permission condition is satisfied,
the printer permitting printing of one or more sheets in excess of the number of printable sheets; and
the printer updating the sheet information by counting the number of actually printed sheets that have been printed in the printer after the printer permitting, the number of actually printed sheets including an excessive number of sheets printed in excess of the number of printable sheets after the permitting; and
when the permission condition is not satisfied, the printer prohibiting the printing of one or more sheets in excess of the number of printable sheets.
